(19) United States
(12) Patent Application Publication
(10) Pub. No.: US 2014/0098096 A1
(43) Pub. Date: Apr. 10, 2014

(54) DEPTH TEXTURE DATA STRUCTURE FOR RENDERING AMBIENT OCCLUSION AND METHOD OF EMPLOYMENT THEREOF

(71) Applicant: NVIDIA CORPORATION, Santa Clara, CA (US)

(72) Inventor: Louis Bavoil, Courbevoie (FR)

(73) Assignee: Nvidia Corporation, Santa Clara, CA (US)

(21) Appl. No.: 13/646,909

(22) Filed: Oct. 8, 2012

(51) Int. Cl. G06T 15/40

(52) U.S. Cl. 345/422

(57) ABSTRACT

A graphics processing subsystem operable to efficiently render an ambient occlusion texture. In one embodiment, the graphics processing subsystem includes: (1) a memory configured to store a depth data structure according to which a full-resolution depth texture is represented by a plurality of unique reduced-resolution depth sub-textures, and (2) a graphics processing unit configured to communicate with the memory via a data bus, and, for a given pixel, execute a program to employ the plurality of unique reduced-resolution depth sub-textures to compute a plurality of coarse ambient occlusion textures, and to render the plurality of coarse ambient occlusion textures as a single full-resolution ambient occlusion texture for the given pixel.

### TECHNICAL FIELD

This application is directed, in general, to computer graphics and, more specifically, to techniques for approximating ambient occlusion in graphics rendering.

### BACKGROUND

Many computer graphic images are created by mathematically modeling the interaction of light with a three dimensional scene from a given viewpoint. This process, called “rendering,” generates a two-dimensional image of the scene from the given viewpoint, and is analogous to taking a photograph of a real-world scene.

As the demand for computer graphics, and in particular for real-time computer graphics, has increased, computer systems with graphics processing subsystems adapted to accelerate the rendering process have become widespread. In these computer systems, the rendering process is divided between a computer's general purpose central processing unit (CPU) and the graphics processing subsystem, architecturally centered about a graphics processing unit (GPU). Typically, the CPU performs high-level operations, such as determining the position, motion, and collision of objects in a given scene. From these high level operations, the CPU generates a set of rendering commands and data defining the desired rendered image or images. For example, rendering commands and data can define scene geometry, lighting, shading, texturing, motion, and/or camera parameters for a scene. The graphics processing subsystem creates one or more rendered images from the set of rendering commands and data.

Scene geometry is typically represented by geometric primitives, such as points, lines, polygons (for example, triangles and quadrilaterals), and curved surfaces, defined by one or more two- or three-dimensional vertices. Each vertex may have additional scalar or vector attributes used to determine qualities such as the color, transparency, lighting, shading, and animation of the vertex and its associated geometric primitives. Scene geometry may also be approximated by a depth texture representing view-space Z coordinates of opaque objects covering each pixel.

Many graphics processing subsystems are highly programmable through an application programming interface (API), enabling complicated lighting and shading algorithms, among other things, to be implemented. To exploit this programmability, applications can include one or more graphics processing subsystem programs, which are executed by the graphics processing subsystem in parallel with a main program executed by the CPU. Although not confined merely to implementing shading and lighting algorithms, these graphics processing subsystem programs are often referred to as “shading programs,” “programmable shaders,” or simply “shaders.”

Ambient occlusion, or AO, is an example of a shading algorithm. AO is not a natural lighting or shading phenomenon. In an ideal system, each light source would be modeled to determine precisely the surfaces it illuminates and the intensity at which it illuminates them, taking into account reflections and occlusions. This presents a practical problem for real-time graphics processing: rendered scenes are often very complex, incorporating many light sources and many surfaces, such that modeling each light source becomes computationally overwhelming and introduces large amounts of latency into the rendering process. AO algorithms address the problem by modeling light sources with respect to an occluded surface in a scene: as white hemi-spherical lights of a specified radius, centered on the surface and oriented with a normal vector at the occluded surface. Surfaces inside the hemi-sphere cast shadows on other surfaces. AO algorithms approximate the degree of occlusion caused by the surfaces, resulting in concave areas such as creases or holes appearing darker than exposed areas. AO gives a sense of shape and depth in an otherwise “flat-looking” scene.

Several methods are available to compute AO, but its sheer computational intensity makes it an unjustifiable luxury for most real-time graphics processing systems. To appreciate the magnitude of the effort AO entails, consider a given point on a surface in the scene and a corresponding hemi-spherical normal-oriented light source surrounding it. The illumination of the point is approximated by integrating the light reaching the point over the hemi-spherical area. The fraction of light reaching the point is a function of the degree to which other surfaces obstruct each ray of light extending from the surface of the sphere to the point. Accordingly, developers are focusing their efforts on reducing the computational intensity of AO algorithms by reducing the number of samples used to evaluate the integral or ignoring distant surfaces altogether. Continued efforts in this direction are likely to occur.

### SUMMARY

One aspect provides a graphics processing subsystem, comprising: (1) a memory configured to store a depth data structure according to which a full-resolution depth texture is represented by a plurality of unique reduced-resolution depth sub-textures, and (2) a graphics processing unit configured to communicate with the memory via a data bus, and, for a given pixel, execute a program to employ the plurality of unique reduced-resolution depth sub-textures to compute a plurality of coarse ambient occlusion textures, and to render the plurality of coarse ambient occlusion textures as a single full-resolution ambient occlusion texture for the given pixel.

Another aspect provides a graphics processing subsystem, comprising: (1) a memory configured to store a depth data structure according to which a full-resolution depth texture is represented by a plurality of unique reduced-resolution depth sub-textures, (2) and a graphics processing unit configured to communicate with the memory via a data bus, and, for a given pixel, execute a program to employ the plurality of unique reduced-resolution depth sub-textures to compute a plurality of coarse ambient occlusion textures, and to render the plurality of coarse ambient occlusion textures as a single full-resolution ambient occlusion texture for the given pixel, the program configured to: (2a) sample the reduced-resolution depth sub-textures about the given pixel and (2b) interleave the coarse ambient occlusion textures derived from the reduced-resolution depth sub-textures sampled about the given pixel.

Another aspect provides a method for rendering a full-resolution ambient occlusion texture, comprising: (1) accessing a full-resolution depth texture, (2) restructuring the full-resolution depth texture into a plurality of unique reduced-resolution depth sub-textures, and offsetting each of the reduced-resolution depth sub-textures by at least one texel in at least one dimension, (3) sampling a first reduced-resolution depth sub-texture about a given pixel, yielding a plurality of depth samples, (4) employing the plurality of depth samples and a normal vector for the given pixel to compute a coarse ambient occlusion texture for the given pixel, (5) repeating an inner-loop that includes the sampling step and the employing step for a plurality of pixels, and (6) repeating an outer-loop that includes the inner-loop and an interleaving of coarse ambient occlusion contributions computed by the inner-loop for each subsequent unique reduced-resolution depth sub-texture, the interleaving resulting in a per-pixel full-resolution ambient occlusion value.

### BRIEF DESCRIPTION

Reference is now made to the following descriptions taken in conjunction with the accompanying drawings, in which:

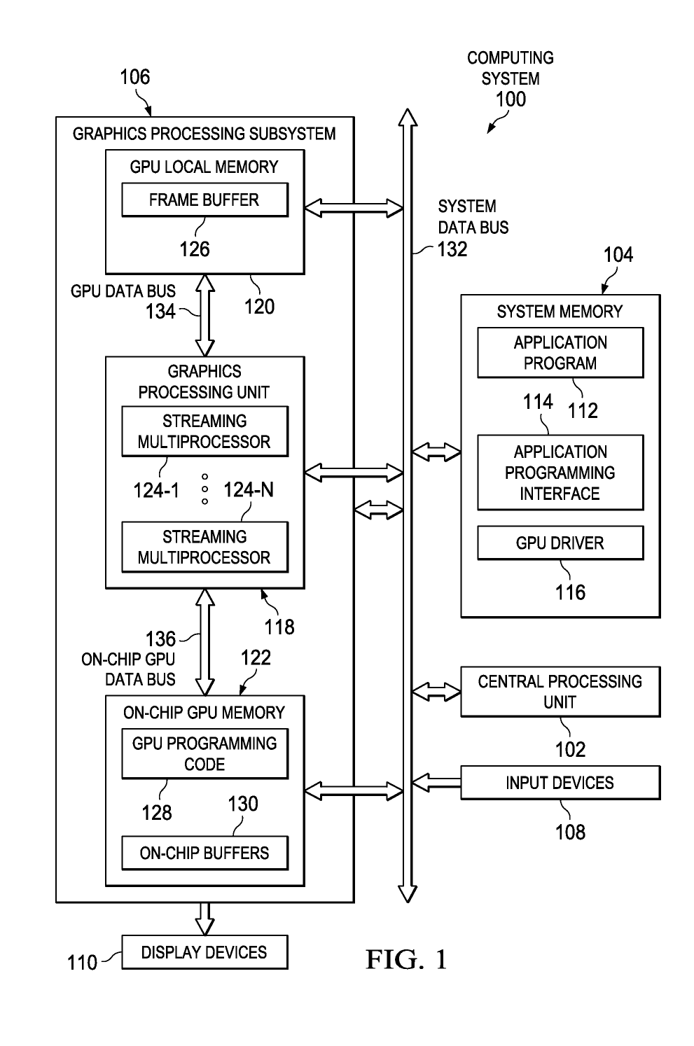

FIG. 1 is a block diagram of one embodiment of a computing system in which one or more aspects of the invention may be implemented;

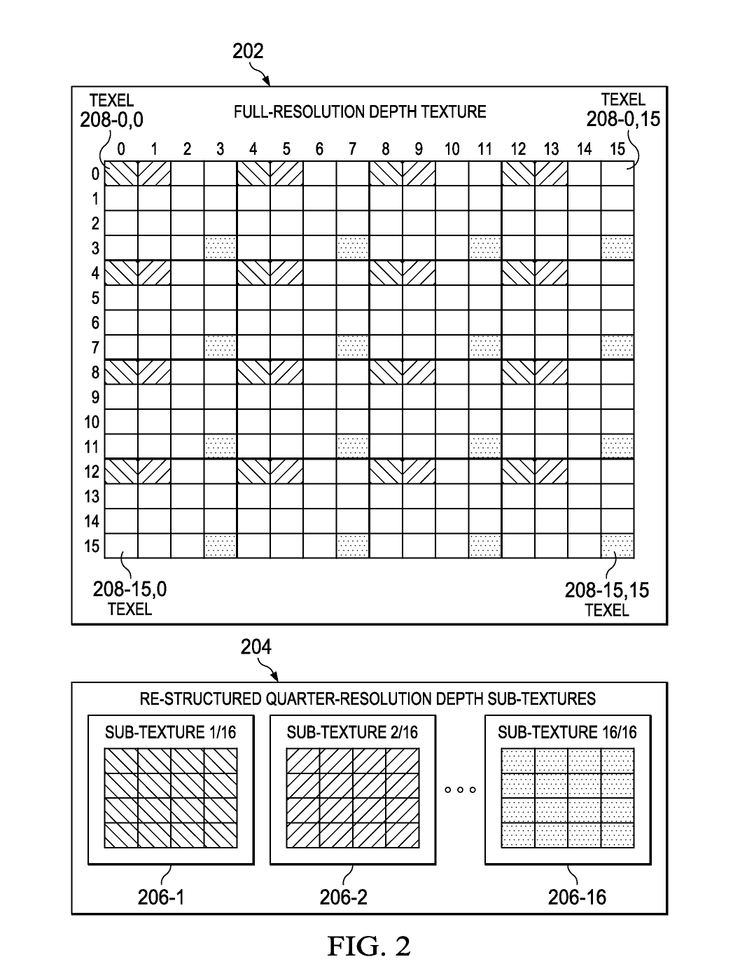

FIG. 2 is an illustration of one embodiment of a restructuring of a full-resolution depth texture into multiple reduced-resolution depth sub-textures;

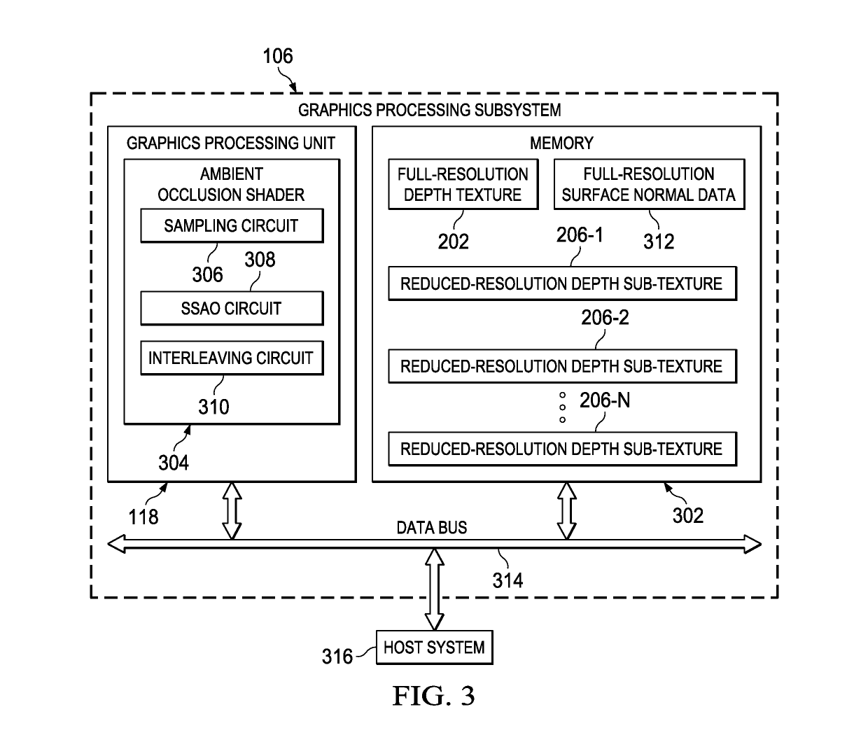

FIG. 3 is a block diagram of one embodiment of a graphics processing subsystem configured to render an ambient occlusion texture; and

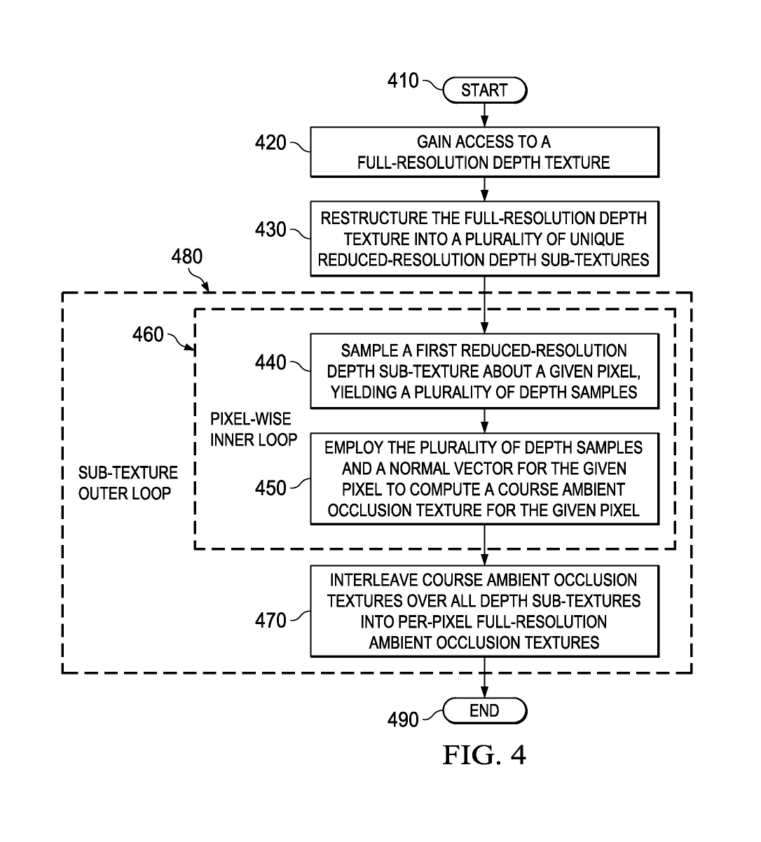

FIG. 4 is a flow diagram of one embodiment of a method of rendering a full-resolution ambient occlusion texture.

### DETAILED DESCRIPTION

Before describing various embodiments of the data structure or method introduced herein, AO will be generally described.

A well-known class of AO algorithm is screen-space AO, or SSAO. SSAO algorithms derive AO from the position of the nearby potentially occluding surface with respect to the position of the occluded point and a surface normal vector at the point. The surface normal vector is employed to orient a hemisphere within which surfaces are considered potential occluding surfaces, or simply “occluders.” Surfaces in the scene are constructed in screen-space from a depth buffer. The depth buffer contains a per-pixel representation of a Z-axis depth of each pixel rendered, the Z-axis being normal to the display plane or image plane (also the XY-plane). The depth data forms a depth texture for the scene. A texel represents the texture value at a single pixel.

One variety of SSAO is horizon-based AO, or HBAO. HBAO involves computing a horizon line from the shaded pixel to a nearby occluding surface. The AO value for that surface is a sinusoidal relationship between the angle formed by the horizon line and the XY-plane and the angle formed by a surface tangent line at the shaded pixel and the XY-plane, viz.:

AO=sin(Θ_{horizon})−sin(Θ_{tangent})

Nearby surfaces are sampled by fetching depth buffer data for multiple pixels along a line extending radially from the shaded pixel in a direction chosen randomly from a uniform probability distribution. The pixels on a single radial line are selected by a fixed step, beginning near the shaded pixel and marching away. The HBAO result is an average over all sample pixels. The quality of the HBAO approximation increases with the number of directions sampled and the number of steps in each direction.

Another variety of SSAO algorithm is crease shading. Crease shading employs the same depth buffer and normal data as HBAO, but calculates AO for each sample as a dot-product between the surface normal vector and a vector extending from the shaded pixel to the occluding surface. Both the HBAO and crease shading provide for scaling, causing near surfaces to occlude more than far surfaces. Both HBAO and crease shading also attribute greater occlusion to surfaces faced by the shaded pixel (i.e., the surface normal vector).

The SSAO algorithms are executed for each pixel in a scene, and then repeated for each frame. Thus, each frame requires accessing the surface normal vectors for each pixel from memory, sampling nearby pixels for each pixel, and fetching depth buffer data for each sample pixel for each pixel in the scene. Finally, the AO is calculated via some method such as HBAO or crease shading discussed above. Inefficiencies are introduced by the random sampling about each pixel, and the subsequent fetching of random samples of depth buffer data, or texels, from memory. As AO is processed, recently fetched texels are cached in a block of memory called a texture cache, along with adjacent texels in a cache line. Once a texel is fetched, the latency of subsequent fetch operations is reduced if the texel may be fetched from the texture cache. However, the size of the texture cache is limited, meaning as a texel fetch becomes “stale” (less recent), the likelihood of a texture cache “hit” diminishes. Random sampling of the full-resolution depth texture for each pixel in a scene results in adjacent pixels fetching non-adjacent depth texels for AO processing. As AO is processed for each pixel, the texture cache is continually flushed of texels from the preceding pixel, making the fetching of depth buffer data a slow process. This is known as “cache trashing.”

Developers often rely on down-sampled textures to reduce cache trashing. Down-sampling of the depth texture creates a low-resolution depth texture that speeds up memory access times, but results in a less accurate rendering of AO. As the AO processing samples the low-resolution depth texture, adjacent pixels are more likely to consider the same texels as potential occluders, increasing the texture cache hit rate, but sacrificing the detail from the lost depth data.

As stated in the Background above, developers are focusing their efforts on reducing the computational intensity of AO algorithms by down-sampling source texture data or considering only proximate surfaces. Their efforts have resulted in AO algorithms that may be practical to execute on modern graphics processing systems in real-time, but do not yield realistic textures. It is fundamentally realized herein that down-sampling or ignoring occluding surfaces will not produce satisfactory realism. Instead, it is realized herein that an SSAO texture should be rendered using the full-resolution depth texture, because the full-resolution depth texture provides the greatest available detail in the final AO texture.

It is further fundamentally realized that the data structure employed to store the depth texture can be a significant source of cache trashing and resulting computational inefficiency. It is realized herein that the depth texture data structure can be reformed to improve the texture cache hit rate. More specifically, it is realized that, rather than storing the depth data in a single full-resolution depth texture, the same amount of depth data may be represented in multiple reduced-resolution depth sub-textures. Each sub-texture contains a fraction of the texels of the full-resolution texture. When sampled, each sub-texture results in an improved texture cache hit rate. In certain embodiments, each sub-texture contains depth data offset in screen-space by at least one full-resolution texel in both the X- and Y-dimensions, from depth data contained in an adjacent sub-texture.

After processing each sub-texture in a reduced-resolution pass, the results from the reduced-resolution passes can be combined to produce a full-resolution AO approximation. Thus, AO processing is executed for each pixel in the scene in multiple, reduced-resolution AO passes. Each reduced-resolution pass considers a single unique depth sub-texture for AO processing. Each sub-texture is sampled about each pixel and a reduced-resolution coarse AO texture likewise produced.

It is further realized herein that uniformly sampling the single sub-texture about adjacent pixels results in adjacent pixels frequently fetching the same texels, thus improving the texture cache hit rate and the overall efficiency of the AO algorithm. The coarse AO textures for each reduced-resolution pass are interleaved to produce a pixel-wise full-resolution AO texture. This amounts to an AO approximation using the full-resolution depth texture, the full-resolution surface normal data, and the same number of samples per pixel as a single full-resolution pass; but with a fraction of the latency due to the cache-efficient restructuring of the full-resolution depth texture.

Various embodiments of the data structure and method introduced herein produce a high quality AO approximation. The interleaved sampling provides the benefits of anti-aliasing found in random sampling and the benefits of streamlined rendering algorithm execution found in regular grid sampling. The sampling pattern begins with a pseudo-random base pattern that spans multiple texels (e.g., four or eight texels). In certain embodiments, the number of sample elements in the base pattern is equal to the number of coarse AO textures, which aims to maximize the texture cache hit rate.

The base pattern is then repeated over an entire scene such that the sampling pattern for any one pixel is random with respect to each adjacent pixel, but retains the regularity of a traditional grid pattern that lends itself to efficient rendering further down the processing stream.

In certain embodiments, the novel, cache-efficient SSAO method described above is augmented with a full-resolution “detailed pass” proximate each pixel. It has been found that the detailed pass can restore any loss of AO detail arising from occlusion by nearby, “thin” surfaces. Nearby surfaces are significant occluders whose occlusive effect may not be captured by interleaving multiple reduced-resolution coarse AO textures when the nearby surface has a thin geometry. Each individual coarse AO texture suffers from some detail loss in its source depth texture, and is susceptible to under-valuing the degree of occlusion attributable to the surface. A traditional full-resolution AO approximation would account for the thin geometry, but is arduous. By only sampling immediately adjacent texels, the detailed pass recovers the lost detail from the coarse AO textures and adds only a small computational cost to the AO processing. The resulting AO texture from the detailed pass can then be combined with the interleaved coarse AO textures.

Before describing various embodiments of the texture data structure and method, a computing system within which the texture data structure may be embodied or carried out will be described.

FIG. 1 is a block diagram of one embodiment of a computing system 100 in which one or more aspects of the invention may be implemented. The computing system 100 includes a system data bus 132, a central processing unit (CPU) 102, input devices 108, a system memory 104, a graphics processing subsystem 106, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, and configures the graphics processing subsystem 106 to perform specific tasks in the graphics pipeline. The system memory 104 typically includes dynamic random access memory (DRAM) employed to store programming instructions and data for processing by the CPU 102 and the graphics processing subsystem 106. The graphics processing subsystem 106 receives instructions transmitted by the CPU 102 and processes the instructions in order to render and display graphics images on the display devices 110.

As also shown, the system memory 104 includes an application program 112, an application programming interface (API) 114, and a graphics processing unit (GPU) driver 116. The application program 112 generates calls to the API 114 in order to produce a desired set of results, typically in the form of a sequence of graphics images. The application program 112 also transmits zero or more high-level shading programs to the API 114 for processing within the GPU driver 116. The high-level shading programs are typically source code text of high-level programming instructions that are designed to operate on one or more shading engines within the graphics processing subsystem 106. The API 114 functionality is typically implemented within the GPU driver 116. The GPU driver 116 is configured to translate the high-level shading programs into machine code shading programs that are typically optimized for a specific type of shading engine (e.g., vertex, geometry, or fragment).

The graphics processing subsystem 106 includes a graphics processing unit (GPU) 118, an on-chip GPU memory 122, an on-chip GPU data bus 136, a GPU local memory 120, and a GPU data bus 134. The GPU 118 is configured to communicate with the on-chip GPU memory 122 via the on-chip GPU data bus 136 and with the GPU local memory 120 via the GPU data bus 134. The GPU 118 may receive instructions transmitted by the CPU 102, process the instructions in order to render graphics data and images, and store these images in the GPU local memory 120. Subsequently, the GPU 118 may display certain graphics images stored in the GPU local memory 120 on the display devices 110.

The GPU 118 includes one or more streaming multiprocessors 124. Each of the streaming multiprocessors 124 is capable of executing a relatively large number of threads concurrently. Advantageously, each of the streaming multiprocessors 124 can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on. Furthermore, each of the streaming multiprocessors 124 may be configured as a shading engine that includes one or more programmable shaders, each executing a machine code shading program (i.e., a thread) to perform image rendering operations. The GPU 118 may be provided with any amount of on-chip GPU memory 122 and GPU local memory 120, including none, and may employ on-chip GPU memory 122, GPU local memory 120, and system memory 104 in any combination for memory operations.

The on-chip GPU memory 122 is configured to include GPU programming code 128 and on-chip buffers 130. The GPU programming 128 may be transmitted from the GPU driver 116 to the on-chip GPU memory 122 via the system data bus 132. The GPU programming 128 may include a machine code vertex shading program, a machine code geometry shading program, a machine code fragment shading program, or any number of variations of each. The on-chip buffers 130 are typically employed to store shading data that requires fast access in order to reduce the latency of the shading engines in the graphics pipeline. Since the on-chip GPU memory 122 takes up valuable die area, it is relatively expensive.

The GPU local memory 120 typically includes less expensive off-chip dynamic random access memory (DRAM) and is also employed to store data and programming employed by the GPU 118. As shown, the GPU local memory 120 includes a frame buffer 126. The frame buffer 126 stores data for at least one two-dimensional surface that may be employed to drive the display devices 110. Furthermore, the frame buffer 126 may include more than one two-dimensional surface so that the GPU 118 can render to one two-dimensional surface while a second two-dimensional surface is employed to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which the texture data structure may be embodied or carried out, various embodiments of the texture data structure and method will be described.

FIG. 2 is an illustration of one embodiment of a restructuring of a full-resolution depth texture 202. The restructuring organizes depth data into multiple reduced-resolution sub-textures. In the illustrated embodiment, the full-resolution depth texture 202 is restructured into quarter-resolution sub-textures 204. In the illustrated embodiment, “quarter-resolution” is with respect to each of the X and Y dimensions, yielding sixteen sub-textures 206-1 through 206-16. Alternative embodiments may restructure the full-resolution depth texture 202 into half-resolution, sixth-resolution, eighth-resolution, or any other fraction of the full-resolution data. The embodiment of FIG. 2 employs a 16×16 resolution texture composed of 256 texels 208-0,0 through 208-15,15. Other embodiments employ a 2560×1600, 1920×1080 or any other image resolution. The embodiment in FIG. 2 divides the 16×16 full-resolution depth texture 202 into sixteen cells illustrated by bold lines. Each sub-texture 206 is composed of each like-positioned texel 208 in each of the sixteen cells. For example, a first sub-texture 206-1 is composed of texels 208-0,0, 208-0,4, 208-0,8, and on through texel 208-12,12. Similarly, a second sub-texture 206-2 is composed of texels 208-0,1, 208-0,5, 208-0,9, . . . , 208-12,13. In the illustrated embodiment, the texels of the second sub-texture 206-2 are offset by one full-resolution texel in the horizontal dimension from the first sub-texture 206-1.

Accordingly, each subsequent sub-texture 206-N is similarly offset in at least one dimension, ending with a final sub-texture 206-16 composed of texels 208-3,3, 208-3,7, 208-3,11, and on through texel 208-15,15.

FIG. 3 is one embodiment of the graphics processing subsystem 106 of FIG. 1, operable to render an AO texture. The graphics processing subsystem 106 contains a memory 302 and a GPU 118 that interface with each other and a host system 316 over a shared data bus 314. Alternative embodiments of the graphics processing subsystem 106 may isolate the host system 316 from either the GPU 118 or the memory 302 or employ a dedicated host interface bus in lieu of the shared data bus 314. Other embodiments may employ a local memory that is integrated within the GPU 118.

In the embodiment of FIG. 3, the memory 302 is configured to store a full-resolution depth texture 202, full-resolution surface normal data 312, and N reduced-resolution depth sub-textures 206-1 through 206-N. In the illustrated embodiment, the depth sub-textures 206 are a reorganized representation of the full-resolution depth texture 202, with no data loss in the reorganization. Other data structure embodiments omit some data, but so little (e.g., less than 10%) that AO plausibility is not substantially compromised. Those data structures are also properly regarded as containing full-resolution data. In still other embodiments, the configured memory 302 may reside in the host system 316 or possibly within the GPU 118 itself.

The embodiment of FIG. 3 includes a GPU 118 configured to execute an AO shader program or “AO shader” 304. The illustrated embodiment of the AO shader 304 includes a sampling circuit 306, a SSAO circuit 308, and an interleaving circuit 310. In other embodiments, the interleaving circuit 310 is incorporated into the SSAO circuit 308. In the embodiment of FIG. 3, the AO shader 304 gains access to the depth sub-textures 206 one at a time via the data bus 314, until all are exhausted. As the AO shader 304 gains access to each of the N depth sub-textures 206, each pixel in an image undergoes AO processing. First, the sampling circuit 306 is configured to sample a depth sub-texture 206-n about a current pixel in the image. The SSAO circuit 308 is configured then to fetch a surface normal vector for the current pixel from the full-resolution surface normal data 312 in the memory 302 via the data bus 314 and compute a coarse AO texture for the current pixel. The interleaving circuit 310 is configured to interleave the coarse AO texture for the current pixel with all other coarse AO textures for the current pixel. AO processing repeats for each pixel in the image before moving on to another of the depth sub-textures 206. The AO processing is then repeated, including operations by the sampling circuit 306, the SSAO circuit 308, and the interleaving circuit 310.

Alternative embodiments of the sampling circuit 306 are configured to employ an interleaved sampling technique that blends a random sampling method with a regular grid sampling method. In these embodiments, a unique random vector per sub-texture is used, helping to further reduce texture-cache trashing, as opposed to using per-pixel randomized sampling. The interleaved sampling produces depth sub-texture samples that are less susceptible to aliasing while also maintaining characteristics that lend themselves to efficient graphics rendering. Another embodiment employs crease shading as its SSAO circuit, while still another employs HBAO.

FIG. 4 is a method for rendering an AO texture. The method begins at a start step 410. At step 420 the full-resolution depth texture is accessed from memory. The full-resolution depth texture is then restructured at step 430 to form a plurality of reduced-resolution depth sub-textures. An alternate embodiment restructures the full-resolution depth texture into sixteen quarter-resolution depth sub-textures. Another embodiment restructures into thirty-six one-sixth-resolution depth sub-textures. An embodiment restructuring into any fraction of the original full-resolution depth texture should see an improvement in efficiency. However, improvements may decline and even reverse as fractions decrease and the resulting numbers of sub-textures increase depending upon the relationship of cache size and depth sub-texture data size.

Returning to the embodiment of FIG. 4, an outer loop 480 is initiated that steps through each of the plurality of depth sub-textures. The outer loop 480 includes an inner loop 460 that steps through each pixel of an image, and an interleaving step 470. The inner loop 460 begins with a sampling step 440 where a depth sub-texture is sampled about a given pixel. Another embodiment employs an interleaved sampling technique for the sampling step 440. In the embodiment of FIG. 4, the depth texture samples generated in the sampling step 440 are employed in an AO computation step 450 whereby a coarse AO texture is computed from a surface normal vector for the given pixel and the depth texture samples. Several methods exist for computing an AO texture. One group of embodiments employs an SSAO algorithm. Of those, one alternate embodiment employs an HBAO algorithm. Another embodiment employs a crease shading algorithm.

Returning again to the embodiment of FIG. 4, the sampling step 440 and the AO computation step 450 are repeated for each pixel in the inner loop 460. The outer loop 480 then interleaves the coarse AO textures for each pixel over all depth sub-textures in an interleaving step 470. Once the outer loop 480 exhausts all depth sub-textures, yielding a pixel-wise AO texture, the method ends at step 490.

In an alternate embodiment, the method of FIG. 4 further executes a detailed pass step before ending at step 490. The detailed pass employs a full-resolution depth texture which is sampled at a low rate about each pixel. The depth texture samples generated are then employed in another AO computation, yielding a pixel-wise detailed AO texture that can be combined with the pixel-wise interleaved AO texture from the outer loop step 480.

Those skilled in the art to which this application relates will appreciate that other and further additions, deletions, substitutions and modifications may be made to the described embodiments.

What is claimed is:

1. A graphics processing subsystem, comprising:
a memory configured to store a depth data structure according to which a full-resolution depth texture is represented by a plurality of unique reduced-resolution depth sub-textures; and
a graphics processing unit configured to communicate with the memory via a data bus and, for a given pixel, execute a program to employ the plurality of unique reduced-resolution depth sub-textures to compute a plurality of coarse ambient occlusion textures, and to render the plurality of coarse ambient occlusion textures as a single full-resolution ambient occlusion texture for the given pixel.

2. The subsystem as recited in claim 1 wherein each of the plurality of unique reduced-resolution depth sub-textures is offset in screen-space by at least one texel in at least one dimension from each other sub-texture of the plurality.

3. The subsystem as recited in claim 2 wherein a single depth sub-texture of the plurality of unique reduced-resolution depth sub-textures is employable by the program to compute a first coarse ambient occlusion texture for each pixel in a scene prior to computing a second coarse ambient occlusion texture for each pixel in the scene.

4. The subsystem as recited in claim 2 wherein the program is operable to iteratively employ a depth sub-texture of the plurality of unique reduced-resolution depth sub-textures to compute a coarse ambient occlusion texture for each pixel in a scene, and operable to interleave each subsequent coarse ambient occlusion texture for each pixel in the scene.

5. The subsystem as recited in claim 1 wherein the plurality of coarse ambient occlusion textures are crease shading approximations.

6. The subsystem as recited in claim 1 wherein the plurality of coarse ambient occlusion textures are computed from an interleaved sampling of texels proximately located with respect to the given pixel.

7. The subsystem as recited in claim 1 wherein the plurality of coarse ambient occlusion textures, for the given pixel, are combined with a full-resolution low-sample ambient occlusion texture.

8. A method of rendering a full-resolution ambient occlusion texture, comprising:
gaining access to a full-resolution depth texture;
restructuring the full-resolution depth texture into a plurality of unique reduced-resolution depth sub-textures, and offsetting each of the reduced-resolution depth sub-textures by at least one texel in at least one dimension;
sampling a first reduced-resolution depth sub-texture about a given pixel, yielding a plurality of depth samples;
employing the plurality of depth samples and a normal vector for the given pixel to compute a coarse ambient occlusion texture for the given pixel;
repeating an inner-loop that includes the sampling step and the employing step for a plurality of pixels; and
repeating an outer-loop that includes the inner-loop and an interleaving of coarse ambient occlusion contributions computed by the inner-loop for each subsequent unique reduced-resolution depth sub-texture, the interleaving resulting in a per-pixel full-resolution ambient occlusion value.

9. The method as recited in claim 8 wherein the unique reduced-resolution depth sub-textures are quarter-resolution depth sub-textures.

10. The method as recited in claim 8 wherein the sampling is an interleaved sampling.

11. The method as recited in claim 8 wherein the employing of the plurality of depth samples and a normal vector for the given pixel employs a screen-space ambient occlusion approximation to compute the coarse ambient occlusion texture for the given pixel.

12. The method as recited in claim 11 wherein the screen-space ambient occlusion approximation is a crease shading computation.

13. The method as recited in claim 11 wherein the screen-space ambient occlusion approximation is a horizon based ambient occlusion computation.

14. The method as recited in claim 8 further comprising:
a per-pixel sampling of a plurality of adjacent texels from the full-resolution depth texture; and
employing the plurality of adjacent texels and the normal vector for the given pixel to compute a detailed ambient occlusion texture, and combining the detailed ambient occlusion texture with the full-resolution ambient occlusion texture.

15. A graphics processing subsystem, comprising:
a memory configured to store a depth data structure according to which a full-resolution depth texture is represented by a plurality of unique reduced-resolution depth sub-textures; and
a graphics processing unit configured to communicate with the memory via a data bus and, for a given pixel, execute a program to employ the plurality of unique reduced-resolution depth sub-textures to compute a plurality of coarse ambient occlusion textures, and to render the plurality of coarse ambient occlusion textures as a single full-resolution ambient occlusion texture for the given pixel, the program configured to:
sample the reduced-resolution depth sub-textures about the given pixel, and
interleave the coarse ambient occlusion textures derived from the reduced-resolution depth sub-textures sampled about the given pixel.

16. The subsystem as recited in claim 15 wherein each of the plurality of unique reduced-resolution depth sub-textures is offset in screen-space by at least one texel in at least one dimension from each other sub-texture of the plurality.

17. The subsystem as recited in claim 15 wherein the program is further configured to re-structure the full-resolution depth texture into a plurality of reduced-resolution depth sub-textures.

18. The subsystem as recited in claim 15 wherein the coarse ambient occlusion textures are crease shading approximations.

19. The subsystem as recited in claim 15 wherein the program is configured to sample the reduced-resolution depth sub-textures about the given pixel by an interleaved sampling.

20. The subsystem as recited in claim 15 wherein the program is operable to combine the interleaved coarse ambient occlusion textures with a full-resolution low-sample ambient occlusion texture.
